(19) United States
(12) Patent Application Publication
(10) Pub. No.: US 2008/0219473 A1
(43) Pub. Date: Sep. 11, 2008

(54) SIGNAL PROCESSING METHOD, APPARATUS AND PROGRAM

(75) Inventors: Akihiko SUGIYAMA, Tokyo (JP); Masanori KATO, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 11/850,204

(22) Filed: Sep. 5, 2007

(30) Foreign Application Priority Data
Mar. 6, 2007 (JP) 2007-055147

(51) Int. Cl. H04B 15/00

(52) U.S. Cl. 381/94.4

(57) ABSTRACT

The present invention is characterized in performing noise suppression immediately before or after mixing signals received from a plurality of terminals. Thus, in multi-point connection for a plurality of terminal devices, a mixed signal can be supplied with high sound quality to a receiver terminal, regardless of the presence and performance of the noise suppression function in a transmitter terminal.

### INCORPORATION BY REFERENCE

This application claims the priority based on a Japanese Patent Application No. 2007-55147 filed on Mar. 6, 2007, disclosure of which is incorporated herein in its entirety by reference.

### BACKGROUND ART

The present invention relates to signal processing method, apparatus and program that realize a function of suppressing a noise superposed over a desired voice signal, and more particularly to signal processing method, apparatus and program by which noise suppression is executed in a multi-point control unit.

Remote conference systems capable of connecting a plurality of locations with each other to hold a conference by remotely located participants are widely used. One remote conference system is of a scheme described in Patent Document 1 (JP-P2000-83229A), for example. As shown in FIG. 19, a remote conference system comprises conference terminals 7510, 7520, 7530, 7540, 7550 and 9510, 9520, 9530, 9540, 9550 that are distributed over several locations, and a multi-point control unit (MCU) 8000 for controlling data exchange among the conference terminals. The multi-point control unit 8000 mixes signals supplied from the terminals, and distributes them to all the terminals. In mixing signals, only the signal supplied from a terminal serving as a destination of distribution is excluded. For example, a signal to be distributed to the terminal 7510 is a mixed signal of those supplied from the terminals 7520, 7530, 7540, 7550, 9510, 9520, 9530, 9540 and 9550.

FIG. 20 shows an exemplary configuration of the multi-point control unit 8000. Although the example in FIG. 20 is shown to be a configuration for connecting four locations, any number of locations may be connected. In FIG. 20, received signals from terminals disposed at first-fourth locations are supplied to input terminals 901, 902, 903, 904, respectively. These received signals are demodulated at receivers 931, 932, 933, 934, and decoded at decoders 921, 922, 923, 924. The decoded signals are supplied to a mixer 8010. The mixer 8010 mixes these decoded signals except one from the location serving as a destination of the mixed signal, and generates mixed signals corresponding to the four locations. For example, assume that a mixed signal to be distributed to a terminal connected with the input terminal 901 is supplied to an output terminal 701. At that time, the mixer 8010 receives decoded signals corresponding to the signals supplied to the input terminals 902, 903, 904 via the decoders 922, 923, 924, and mixes them for supply to an encoder 721. The encoder 721 encodes the supplied mixed signal, and transfers it to the transmitter 731. The transmitter 731 applies processing such as modulation to the encoded signal, and transfers it to the output terminal 701. The mixer 8010 is capable of not merely mixing a plurality of signals but also applying a variety of predetermined medium processing (image processing, sound processing, data processing, etc.).

FIG. 21 shows a first exemplary configuration of the terminals 7510, 7520, 7530, 7540, 7550, 9510, 9520, 9530, 9540, 9550. Since these terminals may have the same configuration, the following description will be made focusing upon the terminal 7510. The terminal 7510 includes a noise suppressor 710, an encoder 720, a transmitter 730, a receiver 930, and a decoder 920. The noise suppressor 710 is supplied with an input signal via an input terminal 700. In a common cell phone, the input terminal 700 is supplied with a signal picked up by a microphone (microphone signal). The microphone signal is composed of a voice itself and a background noise, and the noise suppressor 710 suppresses only the background noise while keeping the voice as intact as possible, and transmits the noise-suppressed voice to the encoder 720. The encoder 720 encodes the noise-suppressed voice supplied from the noise suppressor 710 based on an encoding scheme such as CELP. The encoded information is transferred to the transmitter 730 and subjected to modulation, amplification, etc., and thereafter is supplied to a transmission path 800. In other words, the transmitter terminal 7510 applies noise suppressing processing, then performs processing such as voice encoding, and sends the signal to the transmission path. The receiver 930 demodulates a signal received from the transmission path 800, digitizes it, and then transfers it to the decoder 920. The decoder 920 decodes the signal received from the receiver 930, and transfers an audible signal to an output terminal 900. The signal obtained at the output terminal 900 is supplied to a speaker for reproduction as an audible signal.

The noise suppressor 710 is generally known as a noise suppressor (noise suppression system), which suppresses a noise superposed over a desired voice signal. In general, it operates to suppress a noise mixed in a desired voice signal by estimating a power spectrum of a noise component using an input signal converted into a frequency domain, and subtracting the estimated power spectrum from the input signal. By estimating the power spectrum of a noise component in a continuous manner, the technique can be applied to suppression of a non-stationary noise. One noise suppressor is of a scheme described in Patent Document 2 (JP-P2002-204175A), for example.

Another noise suppressor as an implementation having reduced computational complexity is of a scheme described in Non-Patent Document 1 (Proceedings of ICASSP, Vol. I, pp. 473-476, May, 2006.

These schemes have the same basic operation. Specifically, an input signal is converted into a frequency domain with linear conversion; an amplitude component is extracted; and a suppression coefficient is calculated for each frequency component. Then, a product of the suppression coefficient and amplitude for each frequency component, and a phase of the frequency component are combined and inversely converted to obtain a noise-suppressed output. At that time, the suppression coefficient has a value between zero and one, where a suppression coefficient of zero represents complete suppression and results in a zero-output, and a suppression coefficient of one causes the input to be output as is without suppression.

FIG. 22 shows a second exemplary configuration of the terminals 7510, 7520, 7530, 7540, 7550, 9510, 9520, 9530, 9540, 9550. A difference thereof from FIG. 21 showing the first exemplary configuration is in the absence of the noise suppressor 710. This configuration represents a case of a terminal comprising no noise suppressor 710, and in addition, a case in which a user has turned the function off, or the degree of suppression by the noise suppressor 710 is insufficient. By such a terminal, the background noise mixed in a desired signal is insufficiently suppressed and is transmitted to another terminal as is. Moreover, to improve encoding efficiency in a signal segment containing no voice, the encoder 720 in the terminal sometimes has a discontinuous transmission (DTX) function, by which only the background noise level is encoded with a smaller amount of information. In this case, the decoder 920 in the terminal has a function of generating a noise (comfort noise) according to the transmitted background noise level (CNG).

When the conventional terminal described with reference to FIG. 22 is used in a remote conference, sound quality of the mixed signal caught by a participant of the conference is lowered because no noise suppressor 710 is present. This poses a problem that important phrases may be misheard, or the use over a long period of time causes increased fatigue. Even when the terminal having the configuration disclosed in FIG. 21 is used, a similar problem arises when insufficient suppression is made by the noise suppressor 710 or the function of the noise suppressor 710 is disabled. Moreover, the level of a noise added as a comfort noise is not always comfort to all users, and some user may feel the level of the noise is too high.

### SUMMARY OF THE INVENTION

The present invention is made to solve the above-mentioned problems.

The objective of the present invention is to provide signal processing method, apparatus and program capable of supplying a mixed signal with high sound quality to a receiver terminal in multi-point connection for a plurality of terminals, regardless of the presence and performance of the noise suppression function in a transmitter terminal.

The signal processing method, apparatus and program of the present invention are characterized in performing noise suppression immediately before mixing signals received from a plurality of terminals.

More particularly, the signal processing apparatus of the present invention is characterized in comprising a plurality of noise suppressors for receiving a plurality of received signals, suppressing a noise superposed over a desired signal, and then transmitting it to a mixer.

Moreover, the signal processing method, apparatus and program of the present invention are characterized in performing noise suppression after mixing signals received from a plurality of terminals.

More particularly, the signal processing apparatus of the present invention is characterized in comprising a noise suppressor for receiving a plurality of received signals, mixing them, and then suppressing a noise superposed over a desired signal.

### BRIEF DESCRIPTION OF THE DRAWINGS

FIG. 1 is a block diagram showing the best mode for carrying out the present invention;

FIG. 2 is a block diagram showing a configuration of a noise suppressor included in the best mode for carrying out the present invention;

FIG. 3 is a block diagram showing a configuration of a converter included in FIG. 2;

FIG. 4 is a block diagram showing a configuration of an inverse converter included in FIG. 2;

FIG. 5 is a block diagram showing a configuration of a noise estimator included in FIG. 2;

FIG. 6 is a block diagram showing a configuration of an estimated noise calculator included in FIG. 5;

FIG. 7 is a block diagram showing a configuration of an update deciding section included in FIG. 6;

FIG. 8 is a block diagram showing a configuration of a weighted deteriorated voice calculator included in FIG. 5;

FIG. 9 is a graph showing an example of a non-linear function in a non-linear processor included in FIG. 8;

FIG. 10 is a block diagram showing a configuration of a noise suppression coefficient generator included in FIG. 2;

FIG. 11 is a block diagram showing a configuration of an estimated prior SNR calculator included in FIG. 10;

FIG. 12 is a block diagram showing a configuration of a weighted addition section included in FIG. 11;

FIG. 13 is a block diagram showing a configuration of a noise suppression coefficient calculator included in FIG. 10;

FIG. 14 is a block diagram showing a configuration of a suppression coefficient corrector included in FIG. 10;

FIG. 15 is a block diagram showing a second configuration of a suppression coefficient generator included in FIG. 2;

FIG. 16 is a block diagram showing a configuration of a suppression coefficient corrector included in FIG. 15;

FIG. 17 is a block diagram showing a second mode for carrying out the present invention;

FIG. 18 is a block diagram showing a third mode for carrying out the present invention;

FIG. 19 is a block diagram showing a remote conference system;

FIG. 20 is a block diagram showing a configuration of a multi-point control unit included in FIG. 19;

FIG. 21 is a block diagram showing a first exemplary configuration of a terminal included in FIG. 19; and

FIG. 22 is a block diagram showing a second exemplary configuration of the terminal included in FIG. 19.

### EXEMPLARY EMBODIMENTS

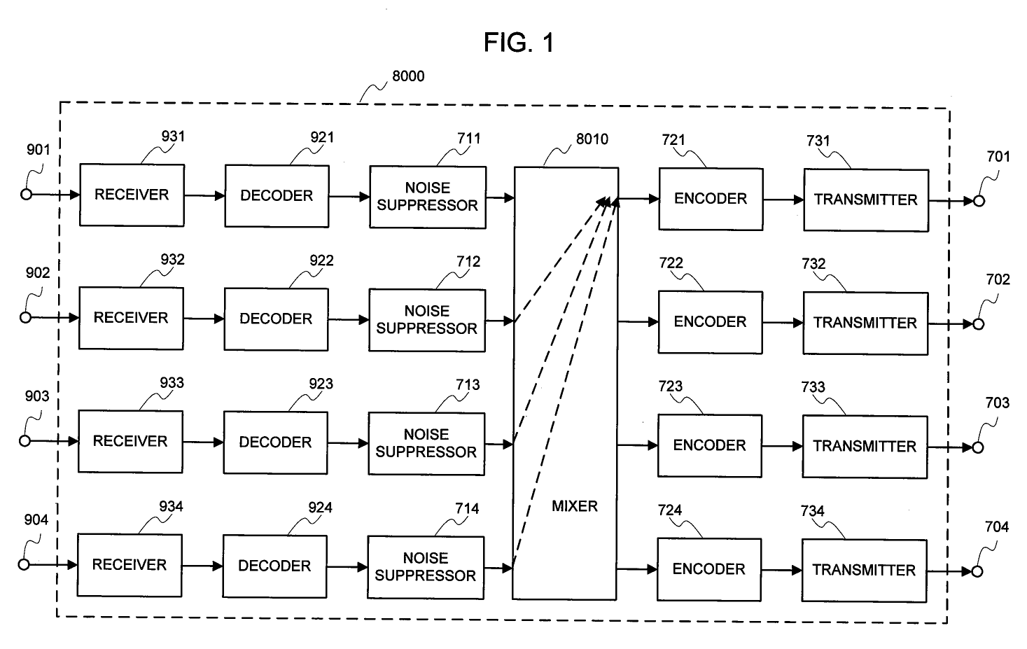

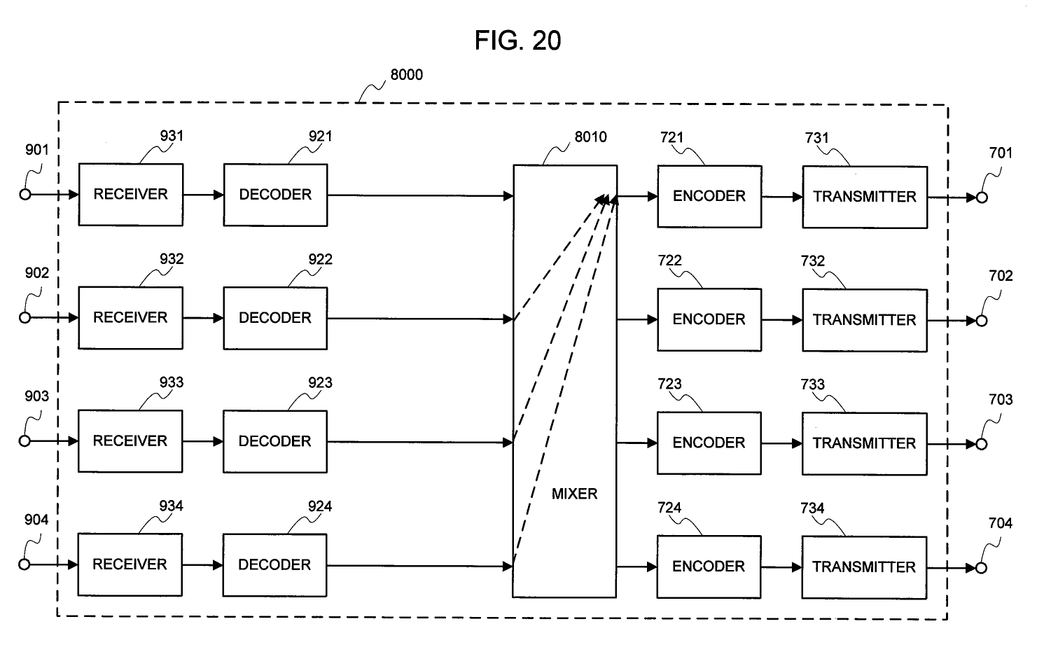

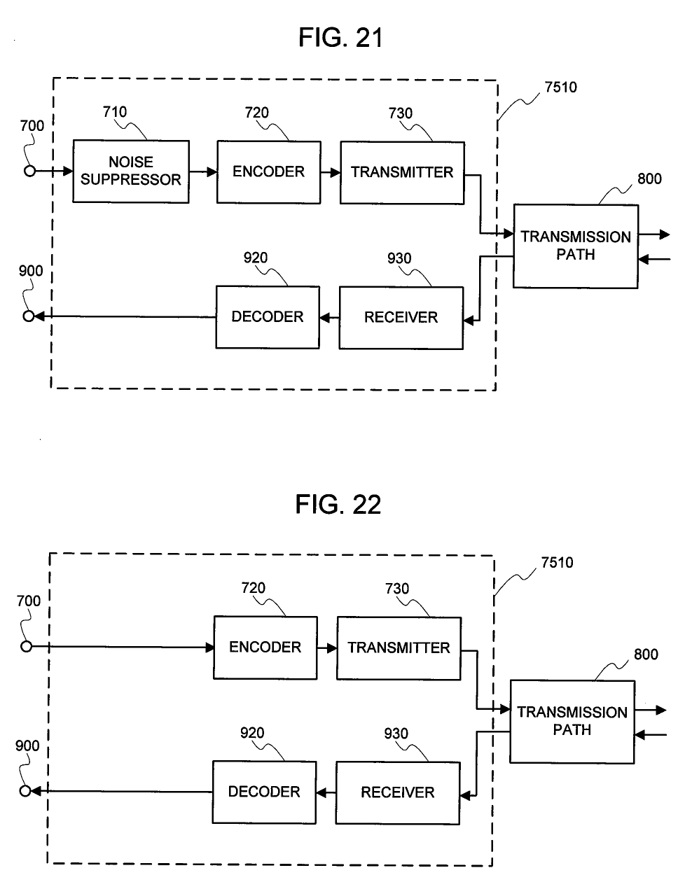

FIG. 1 is a block diagram showing the best mode for carrying out the present invention. FIG. 1 is similar to a prior art of FIG. 20 except for noise suppressors 711, 712, 713, 714. The operation will be described in detail hereinbelow focusing upon the difference.

In FIG. 1, the noise suppressors 711, 712, 713, 714 are provided as post-processing of the decoders 921, 922, 923, 924 in FIG. 20. The noise suppressors 711, 712, 713, 714 receive decoded signals from the decoders 921, 922, 923, 924, respectively, and suppress a noise superposed over a desired signal and a noise added by CNG in the decoders 921, 922, 923, 924. The noise-suppressed signals are supplied to a mixer 8010. The operation subsequent to the mixer 8010 has been described earlier with reference to FIG. 20. The signals supplied to the input terminals 902, 903, 904 are mixed, processed at an encoder 721 and a transmitter 731, and transferred to the output terminal 701. Likewise, signals to be transferred to the output terminals 702, 703, 704 are obtained by processing the signals at the encoders and transmitters, wherein the signals to be transferred to the output terminals 702, 703, 704 each have signals mixed except for that supplied to the input terminals 902, 903, 904, respectively.

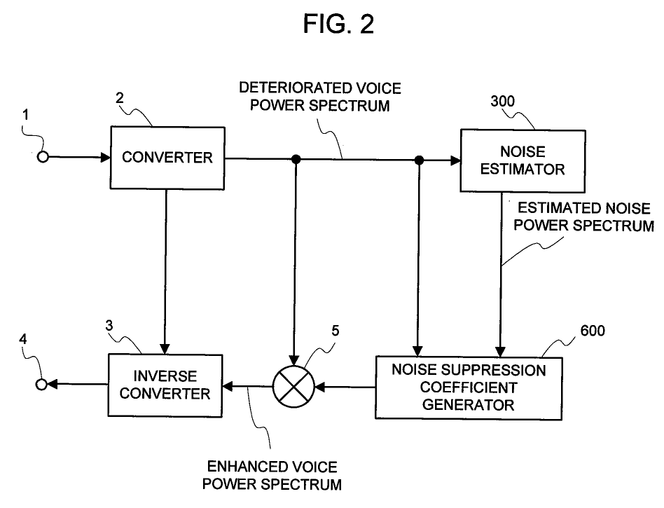

FIG. 2 shows a configuration of the noise suppressors 711, 712, 713, 714. Since these noise suppressors can have the same configuration, the following description will be made with reference to the noise suppressor 711. A decoded signal supplied from the decoder 921 to the noise suppressor 711 is supplied to the input terminal 1 in FIG. 2 as a sequence of sampled values of a deteriorated voice signal (a signal having desired voice signal and noise mixed). The deteriorated voice signal sample undergoes conversion such as Fourier transform at a converter 2, and is decomposed into a plurality of frequency components, whose power spectrum obtained using the amplitude value is multiplexed, and is supplied to a noise estimator 300, a noise suppression coefficient generator 600, and a multiplier 5. A phase is transferred to an inverse converter 3. The noise estimator 300 uses the power spectrum of the deteriorated voice to estimate a power spectrum of the noise contained therein for each of the plurality of frequency components, and transfers it to the noise suppression coefficient generator 600. An example of the noise estimation schemes involves weighting the deteriorated voice with a signal-to-noise ratio in the past to obtain a noise component, detail of which is described in Patent Document 2. The number of the estimated noise power spectra is equal to the number of the frequency components. The noise suppression coefficient generator 600 uses the supplied deteriorated voice power spectrum and estimated noise power spectrum to generate and output a suppression coefficient for multiplication with the deteriorated voice to obtain an enhanced voice in which the noise is suppressed. Since the suppression coefficient is obtained for each frequency component, the output from the suppression coefficient generator 600 is a number of suppression coefficients, which number is equal to the number of frequency components. A widely used example of the noise suppression coefficient generation techniques is a minimum average square short-term spectrum amplitude method in which the average square power of an enhanced voice is minimized, detail of which is described in Patent Document 2. The suppression coefficient generated per frequency is supplied to the multiplier 5. The multiplier 5 multiplies the deteriorated voice supplied from the converter 2 with the suppression coefficient supplied from the noise suppression coefficient generator 600 for each frequency, and transfers the product to the inverse converter 3 as a power spectrum of an enhanced voice. The inverse converter 3 performs inverse conversion such that the phase of the enhanced voice power spectrum supplied from the multiplier 5 is in phase with that of the deteriorated voice supplied from the converter 2, to obtain an enhanced voice signal sample and supplies it to the output terminal 4. While the preceding description has been made on a case in which the power spectrum is employed in the processing, it is generally known that the amplitude value, which corresponds to a square root of the power, may be used instead.

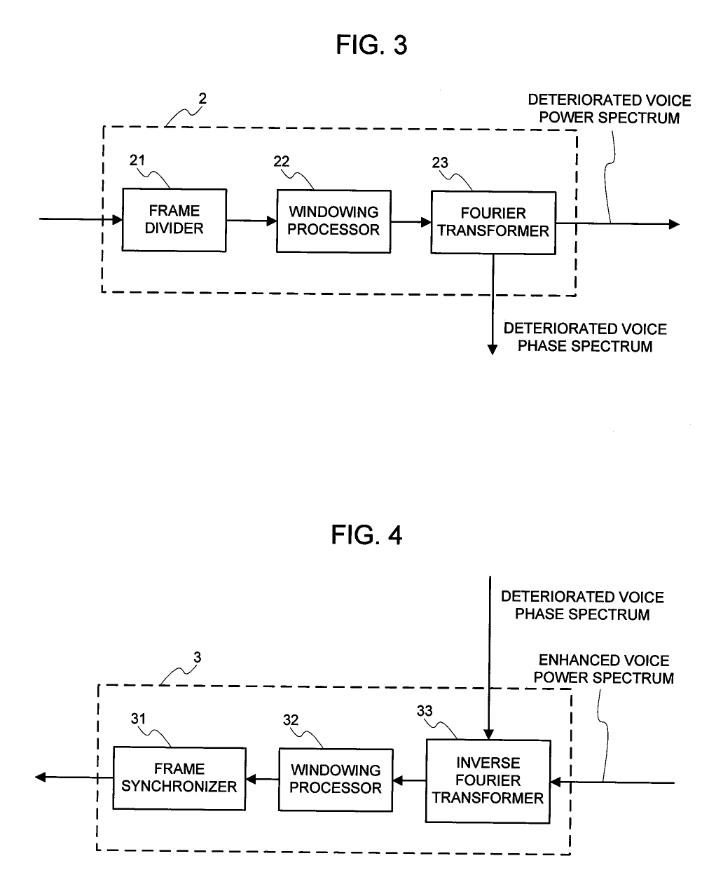

FIG. 3 is a block diagram showing a configuration of the converter 2. The converter 2 is comprised of a frame divider 21, a windowing processor 22, and a Fourier transformer 23. The deteriorated voice signal sample is supplied to the frame divider 21, and divided into frames each having K/2 samples, where K is an even number. The deteriorated voice signal sample divided into frames is supplied to the windowing processor 22, and is multiplied with a window function w(t). A signal yₙ(t)bar obtained by windowing an input signal yₙ(t) (t=0, 1, . . . , K/2-1) with w(t) in an n-th frame is given by the following equation:

y̅ₙ(t)w(t)yₙ(t) [Equation 1]

Moreover, it is a common practice to perform windowing on two consecutive and partially overlapping frames. Assuming that the length of overlap is 50% of the frame length, yₙ(t)bar (t=0, 1, . . . , K−1) obtained for t=0, 1, . . . , K/2−1 according to:

y̅ₙ(t)w(t)yₙ₋₁(t+K/2) y̅ₙ(t+K/2)=w(t+K/2)yₙ(t) [Equation 2]

is an output of the windowing processor 22. A horizontally symmetric window function is used for a real signal. Moreover, the window function is designed so that an input signal for a suppression coefficient set to be one becomes an output signal equal to the input signal aside from a computational error. This means that w(t)+w(t+K/2)=1 stands.

The following description will be made with reference to an example of windowing with 50% of two consecutive frames overlapped. For w(t), a hanning window given by the following equation may be employed, for example:

$$w ( t ) = \{ \begin{matrix}0.5 + 0.5 cos ( \frac{π ( t - K / 2 )}{K / 2} ) , & 0 \leq t < K \\ 0 , & otherwise\end{matrix} \qquad [ Equation 3 ]$$

In addition, there are known a variety of window functions, including hamming window, Kaiser window, Blackman window, and the like. The windowed output yₙ(t)bar is supplied to the Fourier transformer 23, and converted into a deteriorated voice spectrum Yₙ(k). The deteriorated voice spectrum Yₙ(k) is separated into phase and amplitude, and the deteriorated voice phase spectrum argYₙ(k) is supplied to the inverse converter 3 and the deteriorated voice power spectrum |Yₙ(k)|² is supplied to the multiplier 5, noise estimator 300 and noise suppression coefficient generator 600.

FIG. 4 is a block diagram showing a configuration of the inverse converter 3. The inverse converter 3 is comprised of an inverse Fourier transformer 33, a windowing processor 32, and a frame synchronizer 31. The inverse Fourier transformer 33 multiplies an enhanced voice amplitude spectrum |Xₙ(k)| bar obtained using an enhanced voice power spectrum |Xₙ(k)|² bar supplied from the multiplier 5, with the deteriorated voice phase spectrum argYₙ(k) supplied from the converter 2 to calculate an enhanced voice Xₙ(k)bar. That is,

X̅ₙ(k)=| X̅ₙ(k)|·argYₙ(k) [Equation 4]

is executed.

The resulting enhanced voice Xₙ(k)bar is subjected to inverse Fourier transform to obtain a series of time-domain sampled values xₙ(t)bar (t=0, 1, . . . , K−1) comprised of K samples per frame, and supplies it to the windowing processor 32 for multiplication with a window function w(t). A signal xₙ(t)bar windowed with w(t) for an input signal xₙ(t) (t=0, 1, . . . , K/2-1) in an n-th frame is given by the following equation:

x̅ₙ(t)=w(t)xₙ(t) [Equation 5]

Moreover, it is a common practice to perform windowing on two consecutive and partially overlapping frames. Assuming that the length of overlap is 50% of the frame length, yₙ(t)bar (t=0, 1, . . . , K−1) obtained for t=0, 1, . . . , K/2-1 according to:

x̅ₙ(t)=w(t)xₙ₋₁(t+K/2) x̅ₙ(t+K/2)=w(t+K/2)xₙ(t). [Equation 6]

is an output of the windowing processor 32, and is transferred to the frame synchronizer 31. The frame synchronizer 31 takes up K/2 samples each time from two adjacent frames of xₙ(t)bar and makes them overlap with each other to obtain an enhanced voice xₙ(t)hat according to:

\hat{x}ₙ(t)= x̅ₙ₋₁(t+K/2)+ x̅ₙ(t) [Equation 7]

The resulting enhanced voice xₙ(t)hat (t=0, 1, . . . , K−1) is an output of the frame synchronizer 31, and is transferred to the output terminal 4. While in FIGS. 3 and 4, description has been made with reference to Fourier transform that is applied at the converter and inverse converter, other transform such as cosine transform, Hadamard transform, Haar transform, wavelet transform, etc. may be employed in place of Fourier transform as well known in the art.

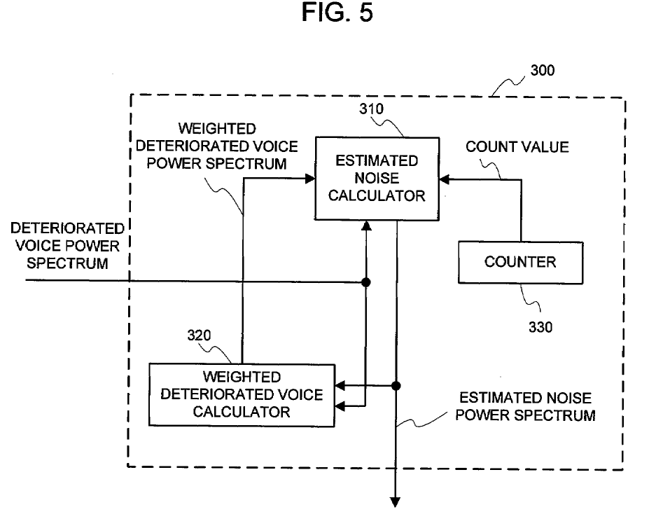

FIG. 5 is a block diagram showing a configuration of the noise estimator 300 in FIG. 2. The noise estimator 300 is comprised of an estimated noise calculator 310, a weighted deteriorated voice calculator 320, and a counter 330. The deteriorated voice power spectrum supplied to the noise estimator 300 is transferred to the estimated noise calculator 310 and weighted deteriorated voice calculator 320. The weighted deteriorated voice calculator 320 uses the supplied deteriorated voice power spectrum and estimated noise power spectrum to calculate a weighted deteriorated voice power spectrum, and transfers it to the estimated noise calculator 310. The estimated noise calculator 310 uses the deteriorated voice power spectrum, weighted deteriorated voice power spectrum, and a count value supplied from the counter 330 to estimate a power spectrum of the noise, outputs the estimated noise power spectrum, and simultaneously therewith, feeds it back to the weighted deteriorated voice calculator 320.

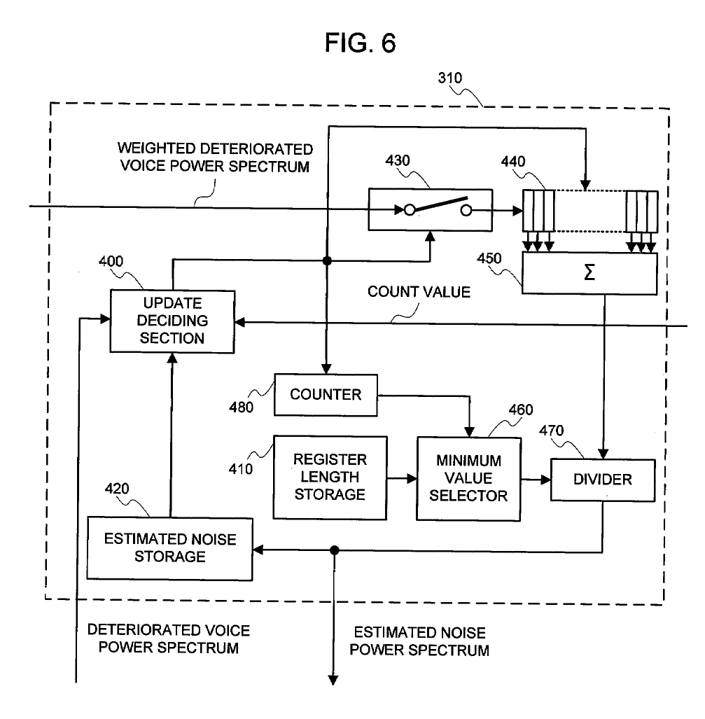

FIG. 6 is a block diagram showing a configuration of the estimated noise calculator 310 included in FIG. 5. It comprises an update deciding section 400, a register length storage 410, an estimated noise storage 420, a switch 430, a shift register 440, an adder 450, a minimum value selector 460, a divider 470, and a counter 480. The switch 430 is supplied with the weighted deteriorated voice power spectrum. When the switch 430 closes the circuit, the weighted deteriorated voice power spectrum is transferred to the shift register 440. The shift register 440 shifts a value stored in its internal registers to adjacent registers in response to a control signal supplied from the update deciding section 400. The shift register length is equal to a value stored in the register length storage 410, which will be discussed later. All register outputs from the shift register 440 are supplied to the adder 450. The adder 450 adds all the supplied register outputs and transfers the result of the addition to the divider 470.

On the other hand, the update deciding section 400 is supplied with the count value, per-frequency deteriorated voice power spectrum, and per-frequency estimated noise power spectrum. The update deciding section 400 always outputs one until the count value reaches a prespecified value, and after the count value has reached the value, outputs one when the input deteriorated voice signal is decided to be a noise and otherwise outputs zero, and transfers the output to the counter 480, switch 430 and shift register 440. The switch 430 closes the circuit when the signal supplied from the update deciding section is one, and opens the circuit when the signal is zero. The counter 480 increments the count value when the signal supplied from the update deciding section is one, and makes no change when the signal is zero. The shift register 440 takes up one of the signal samples supplied from the switch 430 when the signal supplied from the update deciding section is one, and simultaneously therewith, shifts the value stored in its internal registers to adjacent registers. The minimum value selector 460 is supplied with outputs of the counter 480 and of the register length storage 410.

The minimum value selector 460 selects a smaller one of the supplied count value and register length, and transfers it to the divider 470. The divider 470 divides the added value of deteriorated voice power spectrum supplied from the adder 450 by a smaller one of the count value and register length, and outputs the quotient as a per-frequency estimated noise power spectrum λₙ(k). Representing a sampled value of the deteriorated voice power spectrum saved in the shift register 440 as Bₙ(k) (n=0, 1, . . . , N−1), λₙn(k) is given by:

$${λ}_{n} ( k ) = \frac{1}{N} {\sum }_{n = 0}^{N - 1} {B}_{n} ( k ) \qquad [ Equation 8 ]$$

where N is a smaller one of the count value and register length. Since the count value monotonically increases starting with zero, division is initially made by the count value, and later, by the register length. Division by the register length is equivalent to calculation of an average of the values stored in the shift register. Since an insufficient number of values are initially stored in the shift register 440, division is made by the number of registers in which a value is actually stored. The number of registers in which a value is actually stored is equal to the count value when the count value is smaller than the register length, and equal to the register length when the count value is larger than the register length.

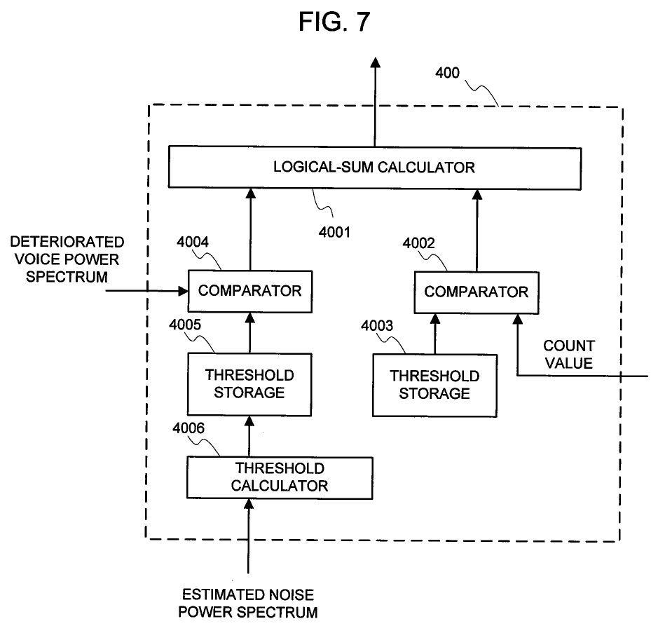

FIG. 7 is a block diagram showing a configuration of the update deciding section 400 included in FIG. 6. The update deciding section 400 comprises a logical-sum calculator 4001, comparators 4004, 4002, threshold storages 4005, 4003, and a threshold calculator 4006. The count value supplied from the counter 330 in FIG. 5 is transferred to the comparator 4002. A threshold that is an output of the threshold storage 4003 is also transferred to the comparator 4002. The comparator 4002 compares the supplied count value with the threshold, and transfers one when the count value is smaller than the threshold, and zero when the count value is larger than the threshold, to the logical-sum calculator 4001. On the other hand, the threshold calculator 4006 calculates a value corresponding to the estimated noise power spectrum supplied from the estimated noise storage 420 in FIG. 6, and outputs it to the threshold storage 4005 as a threshold. The simplest method of calculating the threshold is a constant value times the estimated noise power spectrum. It is also possible to calculate the threshold using a higher-order polynomial or a non-linear function. The threshold storage 4005 stores the threshold output from the threshold calculator 4006, and outputs the threshold stored for an immediately preceding frame to the comparator 4004. The comparator 4004 compares the threshold supplied from the threshold storage 4005 with the deteriorated voice power spectrum supplied from the converter 2 in FIG. 2, and outputs one when the deteriorated voice power spectrum is smaller than the threshold, and zero when the deteriorated voice power spectrum is larger, to the logical-sum calculator 4001. That is, decision is made as to whether the deteriorated voice signal is a noise based on the magnitude of the estimated noise power spectrum. The logical-sum calculator 4001 calculates a logical sum of the output values of the comparators 4202, 4204, and outputs the result of the calculation to the switch 430, shift register 440 and counter 480 in FIG. 6. Thus, the update deciding section 400 outputs one not only in the initial state or in the non-voiced segment but also in the voiced segment having a small deteriorated voice power. That is, the estimated noise is updated. Since the threshold is calculated per frequency, the estimated noise can be updated per frequency.

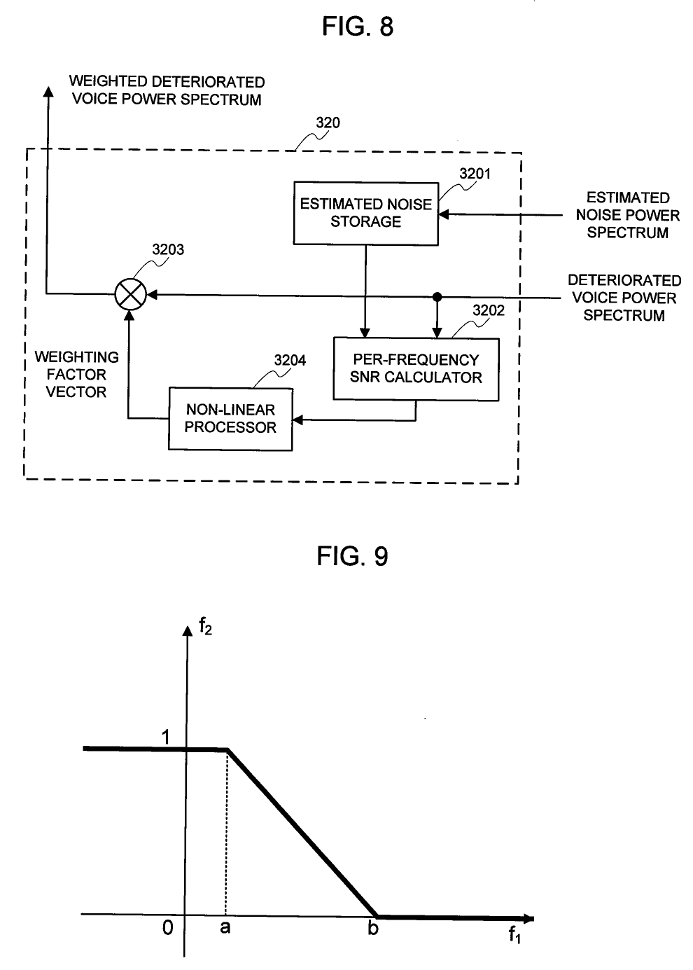

FIG. 8 is a block diagram showing a configuration of the weighted deteriorated voice calculator 320. The weighted deteriorated voice calculator 320 comprises an estimated noise storage 3201, a per-frequency SNR calculator 3202, a non-linear processor 3204, and a multiplier 3203. The estimated noise storage 3201 stores the estimated noise power spectrum supplied from the estimated noise calculator 310 in FIG. 5, and outputs the estimated noise power spectrum stored for an immediately preceding frame to the per-frequency SNR calculator 3202. The per-frequency SNR calculator 3202 uses the estimated noise power spectrum supplied from the estimated noise storage 3201 and deteriorated voice power spectrum supplied from the converter 2 in FIG. 2 to calculate an SNR for each frequency band, and outputs it to the non-linear processor 3204. In particular, the supplied deteriorated voice power spectrum is divided by the estimated noise power spectrum to calculate a per-frequency SNR γₙ(k)hat according to the following equation:

$${\hat{γ}}_{n} ( k ) = \frac{{\vert {Y}_{n} ( k ) \vert}^{2}}{{λ}_{n - 1} ( k )} \qquad [ Equation 9 ]$$

where γₙ₋₁(k) is an estimated noise power spectrum stored for an immediately preceding frame.

The non-linear processor 3204 uses the SNR supplied from the per-frequency SNR calculator 3202 to calculate a weighting factor vector, and outputs it to the multiplier 3203. The multiplier 3203 calculates a product of the deteriorated voice power spectrum supplied from the converter 2 in FIG. 2 and weighting factor vector supplied from the non-linear processor 3204 for each frequency band, and outputs a weighted deteriorated voice power spectrum to the estimated noise calculator 310 in FIG. 5.

The non-linear processor 3204 has a non-linear function that outputs real values corresponding to respective multiplexed input values. FIG. 9 shows an example of the non-linear function. Representing an input value as f₁, an output value f₂ of the non-linear function provided in FIG. 9 is given by:

$${f}_{2} = \{ \begin{matrix}1 , & {f}_{1} \leq a \\ \frac{{f}_{1} - b}{a - b} , & a < {f}_{1} \leq b \\ 0 , & b < {f}_{1}\end{matrix} \qquad [ Equation 10 ]$$

where a and b are arbitrary real numbers.

The non-linear processor 3204 processes the per-frequency-band SNR supplied from the per-frequency SNR calculator 3202 with the non-linear function to obtain a weighting factor, and transfers it to the multiplier 3203. That is, the non-linear processor 3204 outputs a weighting factor from one to zero according to SNR. It outputs one for a smaller SNR and zero for a larger SNR.

The weighting factor multiplied with the deteriorated voice power spectrum at the multiplier 3203 in FIG. 8 has a value corresponding to SNR, and the value of the weighting factor is smaller for a larger SNR, i.e., for a larger voice component contained in the deteriorated voice.

While in general the estimated noise is updated using the deteriorated voice power spectrum, an effect of the voice component contained in the deteriorated voice power spectrum can be reduced by performing weighting on the deteriorated voice power spectrum for use in updating the estimated noise according to SNR, thus achieving noise estimation with higher precision. It should be noted that although a case in which the weighting factor is calculated using a non-linear function is shown herein, it is possible to use for the SNR function expressed in another form, such as linear function or higher-order polynomial, as well as the non-linear function.

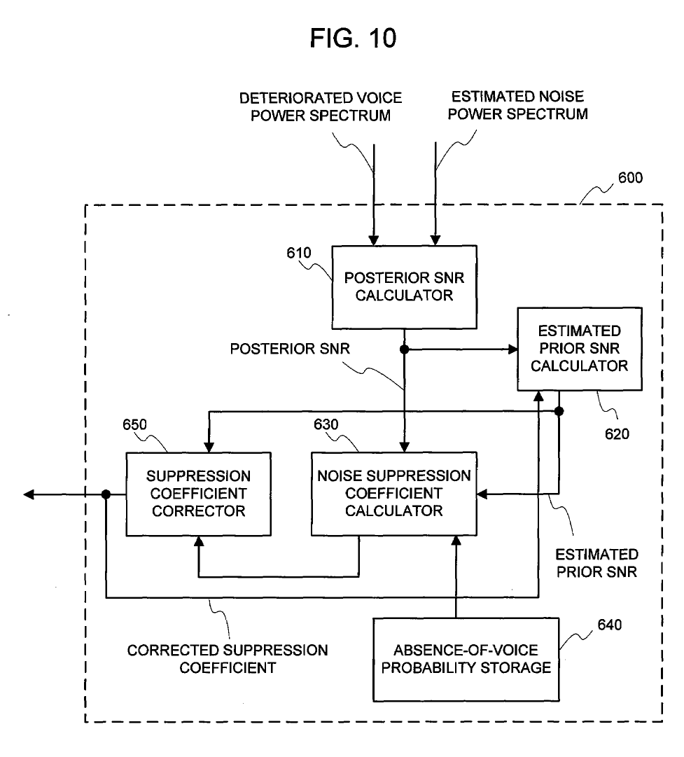

FIG. 10 is a block diagram showing a configuration of the noise suppression coefficient generator 600 included in FIG. 2. The noise suppression coefficient generator 600 comprises a posterior SNR calculator 610, an estimated prior SNR calculator 620, a noise suppression coefficient calculator 630, an absence-of-voice probability storage 640, and a suppression coefficient corrector 650. The posterior SNR calculator 610 uses the input deteriorated voice power spectrum and estimated noise power spectrum to calculate a posterior SNR for each frequency, and supplies it to the estimated prior SNR calculator 620 and noise suppression coefficient calculator 630. The estimated prior SNR calculator 620 uses the input posterior SNR, and a corrected suppression coefficient supplied from the suppression coefficient corrector 650 to estimate a prior SNR, and transfers the estimated prior SNR to the noise suppression coefficient calculator 630. The noise suppression coefficient calculator 630 uses as input the posterior SNR supplied, estimated prior SNR, and an absence-of-voice probability supplied from the absence-of-voice probability storage 640 to generate a noise suppression coefficient, and transfers it to the suppression coefficient corrector 650. The suppression coefficient corrector 650 uses the input estimated prior SNR and noise suppression coefficient to correct the noise suppression coefficient, and outputs the corrected suppression coefficient Gₙ(k)bar.

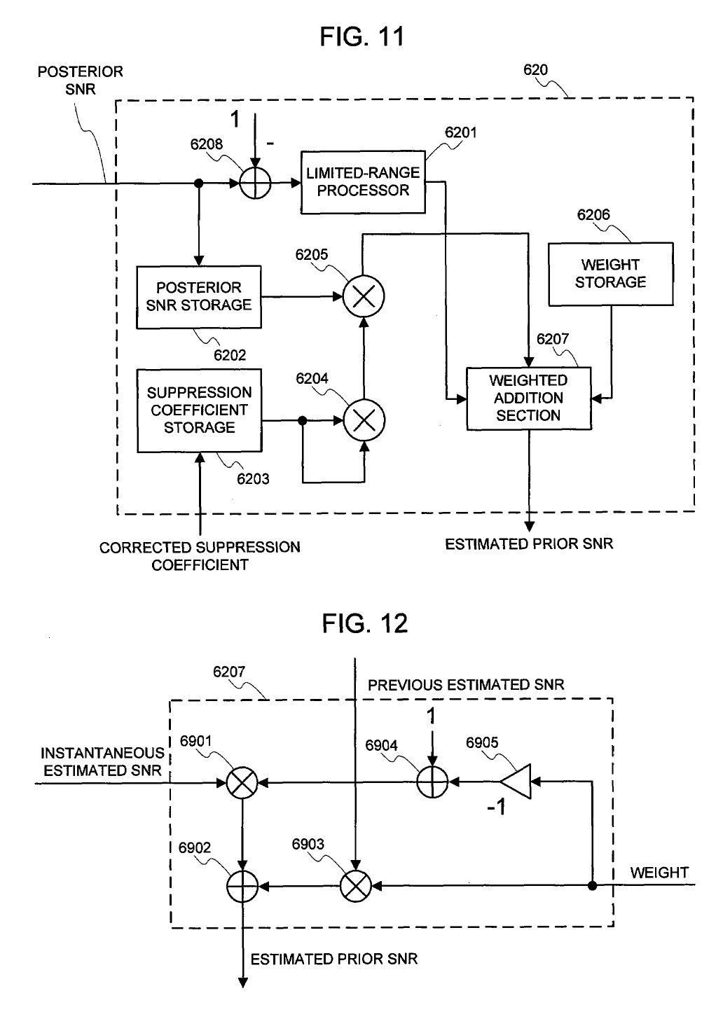

FIG. 11 is a block diagram showing a configuration of the estimated prior SNR calculator 620 included in FIG. 10. The estimated prior SNR calculator 620 comprises a limited-range processor 6201, a posterior SNR storage 6202, a suppression coefficient storage 6203, multipliers 6204, 6205, a weight storage 6206, a weighted addition section 6207, and an adder 6208. A posterior SNR γₙ(k) (k=0, 1, . . . , M−1) supplied from the posterior SNR calculator 610 in FIG. 10 is transferred to the posterior SNR storage 6202 and adder 6208. The posterior SNR storage 6205 stores the posterior SNR γₙ(k) in an n-th frame, and transfers a posterior SNR γₙ₋₁(k) in an (n−1)-th frame to the multiplier 6205. The corrected suppression coefficient Gₙ(k)bar (k=0, 1, . . . , M−1) supplied from the suppression coefficient corrector 650 in FIG. 10 is transferred to the suppression coefficient storage 6203. The suppression coefficient storage 6203 stores the corrected suppression coefficient Gₙ(k)bar in the n-th frame, and transfers a corrected suppression coefficient Gₙ₋₁(k)bar in the (n−1)-th frame to the multiplier 6204. The multiplier 6204 squares the supplied Gₙ(k)bar to calculate G²ₙ₋₁(k)bar, and transfers it to the multiplier 6205. The multiplier 6205 multiplies G²ₙ₋₁(k)bar with γₙ₋₁(k) for k=0, 1, . . . , M−1 to calculate G²ₙ₋₁(k)bar γₙ₋₁(k), and transfers the result to the weighted addition section 6207 as a previous estimated SNR.

Another terminal of the adder 6208 is supplied with minus one, and the result of addition γₙ(k)−1 is transferred to the limited-range processor 6201. The limited-range processor 6201 applies a calculation by a limited-range operator P[·] to the result of addition γₙ(k)−1 supplied from the adder 6208, and transfers the resulting P[γₙ(k)−1] to the weighted addition section 6207 as an instantaneous estimated SNR. P[x] is defined by the following equation:

[Equation 11]

$$P [ x ] = \{ \begin{matrix}x , & x > 0 \\ 0 , & x \leq 0\end{matrix}$$

The weighted addition section 6207 is also supplied with a weight from the weight storage 6206. The weighted addition section 6207 uses these supplied instantaneous estimated SNR, previous estimated SNR and weight to calculate an estimated prior SNR. Representing the weight as α and the estimated prior SNR as ξₙ(k)hat, ξₙ(k)hat is calculated according to the following equation:

\hat{ξ}ₙ(k)=αγₙ₋₁(k) G̅ₙ₋₁²(k)+(1−α)P[γₙ(k)−1] [Equation 12]

where G²₋₁(k) γ₋₁(k)bar=1.

FIG. 12 is a block diagram showing a configuration of the weighted addition section 6207 included in FIG. 11. The weighted addition section 6207 comprises multipliers 6901, 6903, a constant multiplier 6905, and adders 6902, 6904. There are supplied as input the per-frequency-band instantaneous estimated SNR from the limited-range processor 6201 in FIG. 11, per-frequency-band previous SNR from the multiplier 6205 in FIG. 11, and weight from the weight storage 6206 in FIG. 11. The weight having a value of a is transferred to the constant multiplier 6905 and multiplier 6903. The constant multiplier 6905 transfers-α obtained by multiplying the input signal by minus one to the adder 6904. Another input to the adder 6904 is supplied with a value of one, so that the output of the adder 6904 is a sum of them, 1−α. 1−α is supplied to the multiplier 6901 for multiplication with the other input, i.e., per-frequency-band instantaneous estimated SNR P[γₙ(k)−1], and a product (1−α)P[γₙ(k)−1] is transferred to the adder 6902. On the other hand, at the multiplier 6903, a supplied as the weight is multiplied with the previous estimated SNR, and a product αG²ₙ₋₁(k)bar γₙ₋₁(k) is transferred to the adder 6902. The adder 6902 outputs a sum of (1−α)P[γₙ(k)−1] and αG²ₙ₋₁(k)bar γₙ₋₁(k) as a per-frequency-band estimated prior SNR.

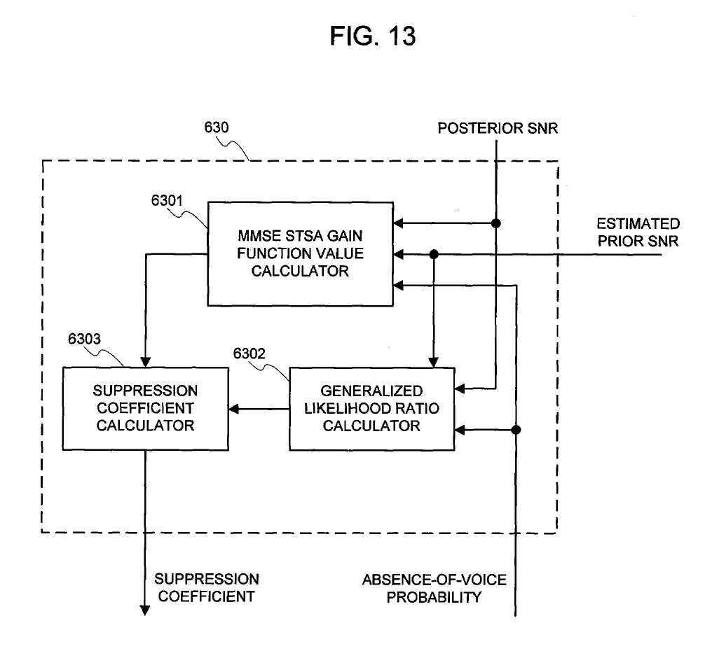

FIG. 13 is a block diagram showing the noise suppression coefficient calculator 630 included in FIG. 10. The noise suppression coefficient calculator 630 comprises an MMSE STSA gain function value calculator 6301, a generalized likelihood ratio calculator 6302, and a suppression coefficient calculator 6303. The following description will be made on a method of calculating a suppression coefficient based on a formula described in Non-patent Document 2 (Non-patent Document 2: IEEE Transactions on Acoustics, Speech, and Signal Processing, Vol. 32, No. 6, pp. 1109-1121, Dec. 1984).

A frame index is denoted by n, a frequency index is denoted by k, γₙ(k) represents a per-frequency posterior SNR supplied from the posterior SNR calculator 610 in FIG. 10, ξₙ(k)hat represents a per-frequency estimated prior SNR supplied from the estimated prior SNR calculator 620 in FIG. 10, and q represents an absence-of-voice probability supplied from the absence-of-voice probability storage 640 in FIG. 10.

Moreover, ηₙ(k)=ξₙ(k)hat/(1−q), and vₙ(k)=(ηₙ(k) γₙ(k))/(1+ηₙ(k)) are assumed. The MMSE STSA gain function value calculator 6301 calculates an MMSE STSA gain function value for each frequency band based on the posterior SNR γₙ(k) supplied from the posterior SNR calculator 610 in FIG. 10, estimated prior SNR ξₙ(k)hat supplied from the estimated prior SNR calculator 620 in FIG. 10, and absence-of-voice probability q supplied from the absence-of-voice probability storage 640 in FIG. 10, and outputs it to the suppression coefficient calculator 6303. The MMSE STSA gain function value Gₙ(k) for each frequency band is given by:

$${G}_{n} ( k ) = \frac{\sqrt{π}}{2} \frac{\sqrt{{v}_{n} ( k )}}{{γ}_{n} ( k )} exp ( - \frac{{v}_{n} ( k )}{2} ) [ ( 1 + {v}_{n} ( k ) ) {I}_{0} ( \frac{{v}_{n} ( k )}{2} ) + {v}_{n} ( k ) {I}_{1} ( \frac{{v}_{n} ( k )}{2} ) ] \qquad [ Equation 13 ]$$

where I₀(z) is a zero-th order modified Bessel function, and I₁(z) is a first-order modified Bessel function. The modified Bessel function is described in Non-patent Document 3 (Non-patent Document 3: Encyclopedia of Mathematics, published by Iwanami Shoten, 1985, p. 374.G).

The generalized likelihood ratio calculator 6302 calculates a generalized likelihood ratio for each frequency band based on the posterior SNR γₙ(k) supplied from the posterior SNR calculator 610 in FIG. 10, estimated prior SNR ξₙ(k)hat supplied from the estimated prior SNR calculator 620 in FIG. 10, and absence-of-voice probability q supplied from the absence-of-voice probability storage 640 in FIG. 10, and transfers it to the suppression coefficient calculator 6303. The generalized likelihood ratio Λₙ(k) for each frequency band is given by:

$${Λ}_{n} ( k ) = \frac{1 - q}{q} \frac{exp ( {v}_{n} ( k ) )}{1 + {η}_{n} ( k )} \qquad [ Equation 14 ]$$

The suppression coefficient calculator 6303 calculates a suppression coefficient for each frequency band using the MMSE STSA gain function value Gₙ(k) supplied from the MMSE STSA gain function value calculator 6301 and generalized likelihood ratio Λₙ(k) supplied from the generalized likelihood ratio calculator 6302, and outputs it to the suppression coefficient corrector 650 in FIG. 10. The suppression coefficient Gₙ(k)bar for each frequency band is given by:

$${\overline{G}}_{n} ( k ) = \frac{{Λ}_{n} ( k )}{{Λ}_{n} ( k ) + 1} {G}_{n} ( k ) \qquad [ Equation 15 ]$$

It is also possible to calculate for use an SNR that is common over a wide band comprised of a plurality of frequency bands, rather than calculating an SNR for each frequency band.

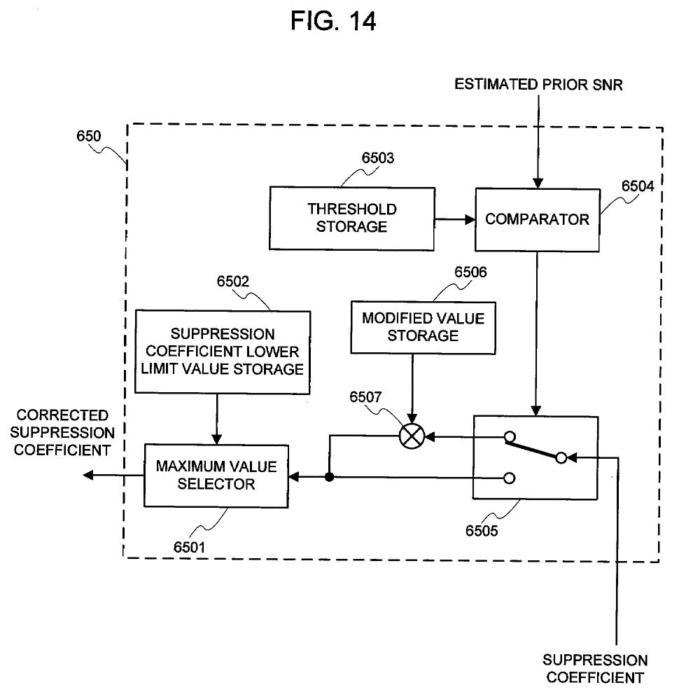

FIG. 14 is a block diagram showing the suppression coefficient corrector 650 included in FIG. 10. The suppression coefficient corrector 650 comprises a maximum value selector 6501, a suppression coefficient lower limit value storage 6502, a threshold storage 6503, a comparator 6504, a switch 6505, a modified value storage 6506, and a multiplier 6507. The comparator 6504 compares a threshold supplied from the threshold storage 6503 with the estimated prior SNR supplied from the estimated prior SNR calculator 620 in FIG. 10, and supplies zero when the estimated prior SNR is larger than the threshold, and one when the estimated prior SNR is smaller, to the switch 6505. The switch 6505 outputs the suppression coefficient supplied from the noise suppression coefficient calculator 630 in FIG. 10 to the multiplier 6507 when the output value of the comparator 6504 is one, and to the maximum value selector 6501 when the output value is zero. That is, the suppression coefficient is corrected when the estimated prior SNR is smaller than the threshold. The multiplier 6507 calculates a product of the output values of the switch 6505 and of modified value storage 6506, and transfers the product to the maximum value selector 6501.

On the other hand, the suppression coefficient lower limit value storage 6502 supplies a lower limit value of the suppression coefficient that it stores, to the maximum value selector 6501. The maximum value selector 6501 compares the suppression coefficient supplied from the noise suppression coefficient calculator 630 in FIG. 10 or the product calculated at the multiplier 6507 with the suppression coefficient lower limit value supplied from the suppression coefficient lower limit value storage 6502, and outputs a larger one of them. That is, the suppression coefficient always becomes a value larger than the lower limit value stored in the suppression coefficient lower limit value storage 6502.

In the preceding modes for carrying out the present invention, description has been made on a case in which the suppression coefficient is independently calculated for each frequency component and used to achieve noise suppression according to Patent Document 2. However, to reduce computational complexity, a suppression coefficient common to a plurality of frequency components may be calculated and used to achieve noise suppression, as disclosed in Non-patent Document 1. In such a case, the configuration additionally comprises a band combining section between the converter 2, and noise estimator 300 and noise suppression coefficient generator 600 in FIG. 2.

Furthermore, as found in Non-patent Document 1, a high-pass filter may be formed in a frequency domain to reduce computational complexity, by providing an offset removing section in front of the converter 2 in FIG. 2 and an amplitude corrector and a phase corrector immediately after the converter 2. In addition, in calculating the suppression coefficient common to a plurality of frequency components, the estimated noise value may be corrected corresponding to a specific frequency band.

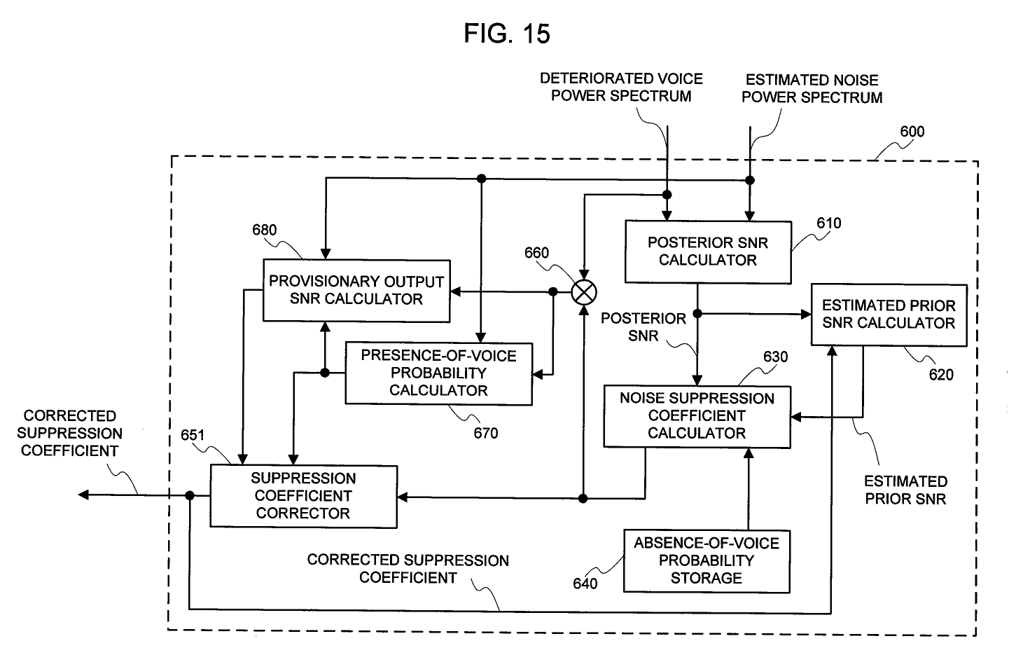

FIG. 15 shows a second embodiment of the noise suppression coefficient generator 600. As compared with the first embodiment shown in FIG. 10, the noise suppression coefficient generator 600 of the second embodiment comprises, in place of the suppression coefficient corrector 650, a suppression coefficient corrector 651, a multiplier 660, a presence-of-voice probability calculator 670, and a provisionary output SNR calculator 680. The presence-of-voice probability calculator 670 and provisionary output SNR calculator 680 are supplied with the estimated noise power spectrum given as an input. The multiplier 660 is supplied with the deteriorated voice power spectrum and suppression coefficient obtained at the noise suppression coefficient calculator 630 given as an input. The multiplier 660 calculates a product thereof as a provisionary output signal, and transfers it to the provisionary output SNR calculator 680 and presence-of-voice probability calculator 670. The presence-of-voice probability calculator 670 uses the estimated noise power spectrum and provisionary output signal to calculate a presence-of-voice probability Vₙ. An example of the presence-of-voice probability that can be used is a ratio of the provisionary output signal to the estimated noise. A larger value of the ratio gives a higher presence-of-voice probability, and a smaller value of the ratio gives a lower presence-of-voice probability. The calculated presence-of-voice probability Vₙ is supplied to the provisionary output SNR calculator 680 and suppression coefficient corrector 651.

The provisionary output SNR calculator 680 uses the estimated noise power spectrum and provisionary output signal to calculate a provisionary output SNR, and transfers it to the suppression coefficient corrector 651. An example of the provisionary output SNR that can be used is a long-term output SNR by the long-term average of the provisionary output and the estimated noise power spectrum. The long-term average of the provisionary output is updated according to the magnitude of the presence-of-voice probability Vₙsupplied from the presence-of-voice probability calculator 670. The calculated provisionary output SNR ξₙ^{L}(k) is supplied to the suppression coefficient corrector 651. The suppression coefficient corrector 651 corrects the suppression coefficient Gₙ(k)bar received from the noise suppression coefficient calculator 630 using the presence-of-voice probability Vₙ received from the presence-of-voice probability calculator 670 and provisionary output SNR ξₙ^{L}(k) received from the provisionary output SNR calculator 680 to output a corrected suppression coefficient Gₙ(k)hat, and simultaneously therewith, feeds it back to the estimated prior SNR calculator 620.

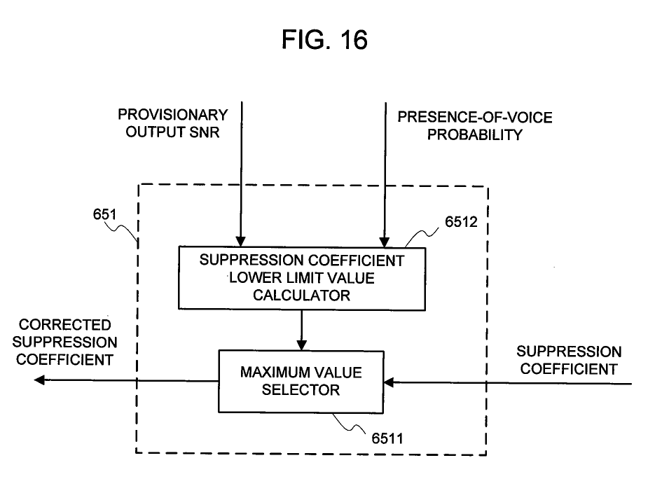

FIG. 16 shows an embodiment of the suppression coefficient corrector 651. The suppression coefficient corrector 651 comprises a suppression coefficient lower limit value calculator 6512 and a maximum value selector 6511. The suppression coefficient lower limit value calculator 6512 is supplied with the provisionary output SNR ξₙ^{L}(k) and presence-of-voice probability Vₙ. The suppression coefficient lower limit value calculator 6512 uses a function A(ξₙ^{L}(k)) and suppression coefficient minimum value fₛ corresponding to a voiced segment to calculate a lower limit value A(Vₙ, ξₙ^{L}(k)) of the suppression coefficient based on the equation below, and transfers it to the maximum value selector 6511.

A(Vₙ,ξₙ^{L}(k))=fₛ·Vₙ+(1−Vₙ)·A(ξₙ^{L}(k)) [Equation 16]

The function A(ξₙ^{L}(k)) basically is of a shape having a smaller value for a larger SNR. The fact that A(ξₙ^{L}(k)) is a function having such a shape corresponding to the provisionary output SNR ξₙ^{L}(k) implies that a higher provisionary output SNR gives a smaller lower limit value of the suppression coefficient corresponding to a non-voiced segment. This corresponds to a smaller residual noise, and provides an effect of reducing discontinuity of sound quality between voiced and non-voiced segments. It should be noted that the function A(ξₙ^{L}(k)) may be different among all frequency components, or may be common to a plurality of frequency components. Moreover, the shape of the function may vary with time.

The maximum value selector 6511 compares the suppression coefficient Gₙ(k)bar received from the noise suppression coefficient calculator 630 with the suppression coefficient lower limit value calculator 6512, and outputs a larger one of them as corrected suppression coefficient Gₙ(k)hat. This processing can be expressed by the following equation:

$${\hat{G}}_{n} ( k ) = \{ \begin{matrix}{\overline{G}}_{n} ( k ) & {\overline{G}}_{n} ( k ) \geq A ( {V}_{n} , {ξ}_{n}^{L} ( k ) ) \\ A ( {V}_{n} , {ξ}_{n}^{L} ( k ) ) & {\overline{G}}_{n} ( k ) < A ( {V}_{n} , {ξ}_{n}^{L} ( k ) )\end{matrix} \qquad [ Equation 17 ]$$

Specifically, in a case that it is likely to be completely a voiced segment, fₛ is set to the suppression coefficient minimum value, and in a case that it is likely to be completely a non-voiced segment, a value determined by a monotonically decreasing function according to the provisionary output SNR ξₙ^{L}(k) is set to the suppression coefficient minimum value. In a situation that it is likely to be intermediate of them, these values are appropriately mixed. A monotonically decreasing nature of A(ξₙ^{L}(k)) ensures a large suppression coefficient minimum value for a low SNR, thus maintaining continuity from an immediately preceding voiced segment in which a large amount of noise is left over from noise removal. Control is made so that the suppression coefficient minimum value is reduced for a higher SNR, resulting in a lower residual noise. This is because the residual noise is so low as to be negligible in the voiced segment and therefore continuity is maintained even when the residual noise is low in the non-voiced segment. Moreover, by setting fₛ to be larger than A(ξₙ^{L}(k)), noise suppression can be mitigated in a voiced segment or likely-to-be voiced segment to reduce distortion occurring in the voice. This is particularly effective when accuracy in noise estimation cannot sufficiently be improved in the voice mixed with distortion introduced by encoding/decoding.

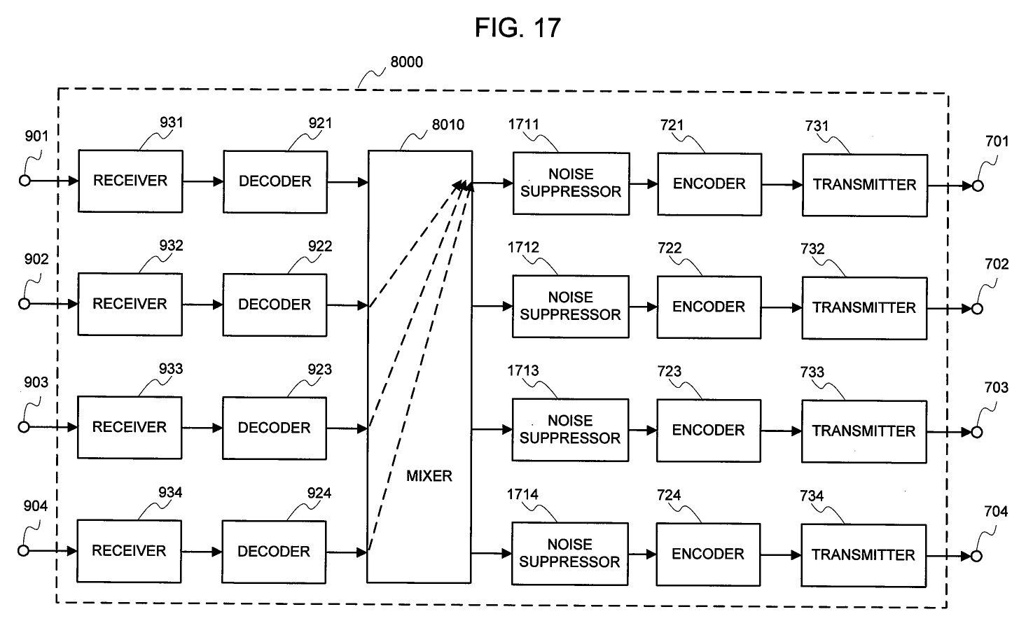

FIG. 17 is a block diagram showing a second mode for carrying out the present invention. FIG. 17 is similar to FIG. 1 representing the best mode except that the noise suppressors 711, 712, 713, 714 are replaced with a noise suppressor 1711 in the multi-point control unit 8000. Unlike the noise suppressors 711, 712, 713, 714, the noise suppressor 1711 is supplied with a mixed signal from the mixer 8010. That is, rather than applying noise suppression to the received signals from the terminals, noise suppression is applied to the mixed signal obtained by mixing the received signals. The noise suppressed signal is encoded at the encoder 721, converted into a transmission signal at the transmitter 731, and then, transmitted to the output terminal 701. A similar operation is performed on the signals transferred to the output terminals 702, 703, 704, detail of which will be omitted because the operation has been described with reference to FIG. 1.

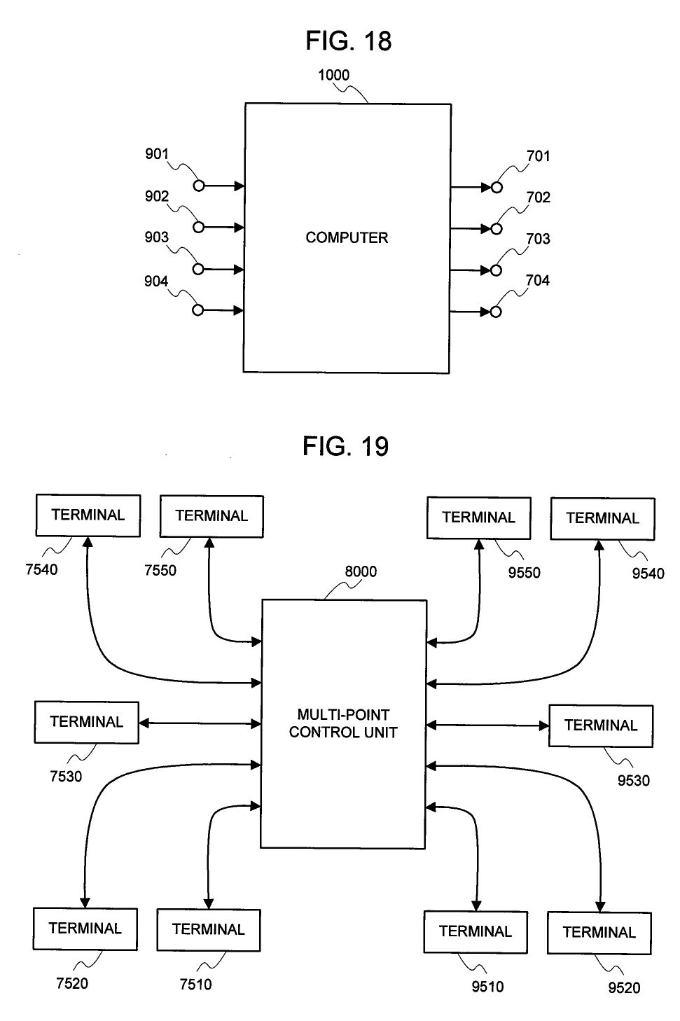

FIG. 18 is a block diagram of a signal processing apparatus based on a third mode for carrying out the present invention. The third mode for carrying out the present invention is comprised of a computer (central processing device; processor; data processing device) 1000 running under the program control, input terminals 901, 902, 903, 904, and output terminals 701, 702, 703, 704. The computer 1000 comprises the receivers 931, 932, 933, 934, decoders 921, 922, 923, 924, noise suppressors 711, 712, 713, 714, mixer 8010, encoders 721, 722, 723, 724, and transmitters 731, 732, 733, 734. Received signals supplied to the input terminals 901-904 are demodulated at the receivers 931-934 in the computer 1000, and deteriorated voices composed of desired signal and noise are restored at the decoders 921-924. The deteriorated voices are suppression-processed at the noise suppressors 711-714 to enhance the desired signal. The enhanced signals are appropriately mixed at the mixer 8010, and corresponding signals are supplied to the encoders 721-724. The signals encoded at the encoders 721-724 are processed at the transmitters 731-734, respectively, and transferred to the corresponding output terminals 701 -704. The computer 1000 may comprise noise suppressors 1741-1744 in place of the noise suppressors 711-714, or it is possible to implement a configuration containing no decoders 921-924 or no encoders 721-724. In a case that the noise suppressor 1741-1744 are included, they perform processing on the signals output from the mixer 8010, respectively, rather than on the signals supplied to the mixer 8010.

While in all the modes for carrying out the present invention described thus far, a minimum average square error short-term spectrum amplitude method is assumed as a scheme of noise suppression, the embodiments are applicable to other methods. Examples of such methods include: a Wiener filtering method as disclosed in Non-patent Document 4 (Non-patent Document 4: Proceedings of the IEEE, Vol. 67, No. 12, pp. 1586-1604, December, 1979), and a spectrum subtraction method as disclosed in Non-patent Document 5 (Non-patent Document 5: IEEE Transactions on Acoustics, Speech, and Signal Processing, Vol. 27, No. 2, pp. 113-120, April, 1979), detailed description of their exemplary configurations being however omitted.

As described above, according to the present invention, noise suppression is performed immediately before mixing signals received from a plurality of terminals.

Thus, a mixed signal can be supplied with high sound quality to a receiver terminal, regardless of the presence and performance of the noise suppression function in a transmitter terminal.

While the invention has been particularly shown and described with reference to embodiments thereof, the invention is not limited to these embodiments. It will be understood by those of ordinary skill in the art that various changes in form and details may be made therein without departing from the spirit and scope of the present invention as defined by the claims.

What is claimed is:

1. A signal processing method comprising steps of:
suppressing noises in a plurality of received signals to generate a plurality of enhanced signals;
mixing said plurality of enhanced signals in different combinations to generate mixed signals; and
transmitting said mixed signals to terminals.

2. A signal processing method according to claim 1, wherein said noises are suppressed after said plurality of received signals are decoded.

3. A signal processing method according to claim 1, wherein, in generating said enhanced signals, said noises are suppressed by:
converting an input signal into a frequency-domain signal;
combining bands of said frequency-domain signal to obtain a combined frequency-domain signal;
obtaining an estimated noise using said combined frequency-domain signal;
determining a suppression coefficient using said estimated noise and said combined frequency-domain signal; and
weighting said frequency-domain signal with said suppression coefficient.

4. A signal processing method according to claim 3, wherein said noises are suppressed by:
obtaining a corrected suppression coefficient using said estimated noise, said combined frequency-domain signal, and said suppression coefficient; and
weighting said frequency-domain signal with said corrected suppression coefficient.

5. A signal processing method according to claim 1, wherein said noises are suppressed by:
converting an input signal into a frequency-domain signal;
obtaining an estimated noise using said frequency-domain signal;
determining a suppression coefficient using said estimated noise and said frequency-domain signal;
correcting said suppression coefficient to obtain a corrected suppression coefficient so that distortion is reduced in a likely-to-be-voiced segment and a residual noise is reduced in a likely-to-be-non-voiced segment; and
weighting said frequency-domain signal with said corrected suppression coefficient.

6. A signal processing method according to claim 5, wherein said method comprises steps of:
obtaining a ratio of an average power in said likely-to-be-voiced segment to an average power in said likely-to-be-non-voiced segment; and
obtaining said corrected suppression coefficient so that said residual noise in said likely-to-be-non-voiced segment is reduced when said ratio has a larger value.

7. A signal processing method comprising steps of:
mixing a plurality of received signals in different combinations to generate mixed signals;
suppressing noises in said mixed signals to generate enhanced signals; and
transmitting said enhanced signals to terminals.

8. A signal processing method according to claim 7, wherein said plurality of received signals are mixed after being decoded.

9. A signal processing method according to claim 7, wherein, in generating said enhanced signals, said noises are suppressed by:
converting an input signal into a frequency-domain signal;
combining bands of said frequency-domain signal to obtain a combined frequency-domain signal;
obtaining an estimated noise using said combined frequency-domain signal;
determining a suppression coefficient using said estimated noise and said combined frequency-domain signal; and
weighting said frequency-domain signal with said suppression coefficient.

10. A signal processing method according to claim 9, wherein said noises are suppressed by:
obtaining a corrected suppression coefficient using said estimated noise, said combined frequency-domain signal, and said suppression coefficient; and
weighting said frequency-domain signal with said corrected suppression coefficient.

11. A signal processing method according to claim 7, wherein said noises are suppressed by:
converting an input signal into a frequency-domain signal;
obtaining an estimated noise using said frequency-domain signal;
determining a suppression coefficient using said estimated noise and said frequency-domain signal;
correcting said suppression coefficient to obtain a corrected suppression coefficient so that distortion is reduced in a likely-to-be-voiced segment and a residual noise is reduced in a likely-to-be-non-voiced segment; and
weighting said frequency-domain signal with said corrected suppression coefficient.

12. A signal processing method according to claim 11, wherein said method comprises steps of:
obtaining a ratio of an average power in said likely-to-be-voiced segment to an average power in said likely-to-be-non-voiced segment; and
obtaining said corrected suppression coefficient so that said residual noise in said likely-to-be-non-voiced segment is reduced when said ratio has a larger value.

13. A signal processing apparatus comprising:
a noise suppressor for suppressing noises in a plurality of received signals to generate a plurality of enhanced signals;
a mixer for mixing said plurality of enhanced signals in different combinations to generate mixed signals; and
a transmitter for transmitting said mixed signals to terminals.

14. A signal processing apparatus according to claim 13, wherein said apparatus comprises a decoder for decoding said plurality of received signals to generate a plurality of decoded signals, and
said noises are suppressed for said plurality of decoded signals.

15. A signal processing apparatus according to claim 13, wherein said noise suppressor comprises:
a converter for converting an input signal into a frequency-domain signal;
a noise estimator for estimating a noise using said frequency-domain signal;
a noise suppression coefficient generator for determining a suppression coefficient using said estimated noise and said frequency-domain signal; and
a multiplier for weighting said frequency-domain signal with said suppression coefficient.

16. A signal processing apparatus according to claim 15, wherein said noise suppressor comprises a suppression coefficient corrector for obtaining a corrected suppression coefficient using said estimated noise, said combined frequency-domain signal, and said suppression coefficient, and
said frequency-domain signal is weighted with said corrected suppression coefficient.

17. A signal processing apparatus according to claim 13, wherein said noise suppressor comprises:
a converter for converting an input signal into a frequency-domain signal;
a noise estimator for estimating a noise using said frequency-domain signal;
a noise suppression coefficient generator for determining a suppression coefficient using said estimated noise and said frequency-domain signal;
a suppression coefficient corrector for obtaining a corrected suppression coefficient using said estimated noise, said frequency-domain signal, and said suppression coefficient; and
a multiplier for weighting said frequency-domain signal with said corrected suppression coefficient, and
said suppression coefficient corrector corrects said suppression coefficient so that distortion is reduced in a likely-to-be-voiced segment and a residual noise is reduced in a likely-to-be-non-voiced segment.

18. A signal processing apparatus according to claim 17, wherein said suppression coefficient corrector:
obtains a ratio of an average power in said likely-to-be-voiced segment to an average power in said likely-to-be-non-voiced segment; and
corrects said suppression coefficient so that said residual noise in said likely-to-be-non-voiced segment is reduced when said ratio has a larger value.

19. A signal processing apparatus comprising:
a mixer for mixing a plurality of received signals in different combinations to generate mixed signals;
a noise suppressor for suppressing noises in said mixed signals to generate enhanced signals; and
a transmitter for transmitting said enhanced signals to terminals.

20. A signal processing apparatus according to claim 19, wherein said apparatus comprises a decoder for decoding said plurality of received signals to generate a plurality of decoded signals, and
said plurality of decoded signals are mixed.

21. A signal processing apparatus according to claim 19, wherein said noise suppressor comprises:
a converter for converting an input signal into a frequency-domain signal;
a noise estimator for estimating a noise using said frequency-domain signal;
a noise suppression coefficient generator for determining a suppression coefficient using said estimated noise and said frequency-domain signal; and
a multiplier for weighting said frequency-domain signal with said suppression coefficient.

22. A signal processing apparatus according to claim 21, wherein said noise suppressor comprises a suppression coefficient corrector for obtaining a corrected suppression coefficient using said estimated noise, said combined frequency-domain signal, and said suppression coefficient, and
said frequency-domain signal is weighted with said corrected suppression coefficient.

23. A signal processing apparatus according to claim 19, wherein said noise suppressor comprises:
a converter for converting an input signal into a frequency-domain signal;
a noise estimator for estimating a noise using said frequency-domain signal;
a noise suppression coefficient generator for determining a suppression coefficient using said estimated noise and said frequency-domain signal;
a suppression coefficient corrector for obtaining a corrected suppression coefficient using said estimated noise, said frequency-domain signal, and said suppression coefficient; and
a multiplier for weighting said frequency-domain signal with said corrected suppression coefficient, and
said suppression coefficient corrector corrects said suppression coefficient so that distortion is reduced in a likely-to-be-voiced segment and a residual noise is reduced in a likely-to-be-non-voiced segment.

24. A signal processing apparatus according to claim 23, wherein said suppression coefficient corrector:
obtains a ratio of an average power in said likely-to-be-voiced segment to an average power in said likely-to-be-non-voiced segment; and
corrects said suppression coefficient so that said residual noise in said likely-to-be-non-voiced segment is reduced when said ratio has a larger value.

25. A signal processing program for causing a computer to execute processing of:
suppressing noises in a plurality of received signals to generate a plurality of enhanced signals;
mixing said plurality of enhanced signals in different combinations to generate mixed signals; and
transmitting said mixed signals to terminals.

26. A signal processing program for causing a computer to execute processing of:
mixing a plurality of received signals in different combinations to generate mixed signals;
suppressing noises in said mixed signals to generate enhanced signals; and
transmitting said enhanced signals to terminals.
